(19) United States
(12) Patent Application Publication
(10) Pub. No.: US 2025/0387279 A1
(43) Pub. Date: Dec. 25, 2025

(54) HARNESS VEHICLE

(71) Applicant: Larry T. WILDE, JR., Hyrum, UT (US)

(72) Inventor: Larry T. WILDE, JR., Hyrum, UT (US)

(21) Appl. No.: 18/879,486

(22) PCT Filed: Jul. 17, 2023
(86) PCT No.: PCT/US2023/027911

§ 371 Date: Dec. 27, 2024

Related U.S. Application Data
(60) Provisional application No. 63/390,285, filed on Jul. 18, 2022.
(60) Provisional application No. 63/462,489, filed on Apr. 27, 2023.

(51) Int. Cl. A61G 5/10; A61G 5/04; A61G 5/08

(52) U.S. Cl. CPC A61G 5/1091; A61G 5/04; A61G 5/08; A61G 5/1005

(57) ABSTRACT

A harness vehicle configured to allow a first user to pull a load—in preferred embodiments a disabled person—over nature, hiking, and other trails, paths, and terrain. The harness vehicle includes: a first frame, load portion, and wheel; and a second frame configured as a back-pack-styled harness and that is releasably attachable to the first frame so as to allow a user to pull the first frame. Embodiments of the harness vehicle are configured to allow a user to convey a load generally hands-free.

### TECHNICAL FIELD AND INDUSTRIAL APPLICABILITY OF THE INVENTION

The invention relates to the field of load-bearing vehicles, including human powered and/or actuator-assisted, load-bearing vehicles for conveying disabled persons.

### BACKGROUND

The World Health Organization (WHO) has stated that disability is a global public health issue that affects one in seven people worldwide. Everybody is likely to experience disability at some point in life. The responsibilities and privileges of caring for people with disabilities fall upon all of us. Significantly, according to the Pew Research Center, the most common types of disability involve difficulties with walking. For example, more than 20 million people ages 18 and older in the United States report serious difficulty walking. This represents over seven percent of the civilian non-institutionalized population. Another 14 million people ages 18 and older have a difficult time performing routine activities due to physical, mental, or emotional conditions.

Needless to say, such restrictions potentially narrow the scope of enriching experiences available to persons with disabilities, or, at minimum, makes them significantly more challenging. One type of potentially restricted experience is backcountry travel. Many studies show that getting outside in the backcountry provides all kinds of health benefits, including emotional and mental relief that comes from being in nature. Spending time outdoors reduces stress, calms anxiety, and can lead to a lower risk of depression. Being outdoors also opens up senses and improves sensory perception. Outdoor therapy can even be prescribed by a doctor. In many instances, getting outdoors with others involves a social component; engaging in activities with friends and family is also very good for physical, mental, and emotional health.

Many people with disabilities need and want the above benefits, and many friends and family members wish to help provide them. Mobility disabilities make experiencing and providing these benefits challenging. In particular, wheelchair designs contemplate either a user or third-party propelling the user on a relatively hard, even, and/or or gently sloping surface with structurally limited mechanical advantage and stability. Accordingly, wheelchair designs make negotiating nature paths, hiking trails, and off-road conditions highly difficult or impossible.

In light of the above, a vehicle is needed to solve the problems of providing outdoor access to persons of disability and those that care for and love them.

### SUMMARY OF THE INVENTION

In accordance with the above, a new and innovative harness vehicle is provided. The problem of providing outdoor access to persons of disability is solved. In a preferred embodiment, harness vehicle is configured to allow a first user to pull a second user or passenger over nature, hiking, and other trails, paths, and terrain, within a system that is designed to optimize comfort, load, and burden on the first user while also achieving stability and relative comfort for the passenger. In other embodiments, the harness vehicle may use other load platforms configured for applications in hunting (e.g., hauling game and/or meat), chores (workload carry), and/or exercise and weightlifting.

Embodiments of the invention include a harness vehicle with a first frame and wheel, a second frame configured as a backpack-styled harness and that is releasably attachable to the first frame so as to allow a user to pull the first frame, and a load portion located on the first frame. Various embodiments of the harness vehicle are configured to allow a user to convey a load generally hands-free such that a first user's hands are not needed in the pulling effort required to convey the harness vehicle.

The invention disclosed herein is related to inventions set forth in U.S. Pat. App. Nos. 63/390,285filed on Jul. 18, 2022, and 63/462,489, filed on Apr. 27, 2023.

These and other aspects of the present invention will become more fully apparent from the following description and appended claim or may be learned by the practice of the invention as set forth hereinafter.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a front perspective view of a first embodiment of a harness vehicle.

FIG. 2 is a rear perspective view of a first embodiment of a harness vehicle.

FIG. 3 is a front perspective view of a second embodiment of a harness vehicle.

FIG. 4 is a front perspective view of a first embodiment of a harness vehicle in an environment of a puller and a passenger.

FIG. 5 is a side view of a first embodiment of a harness vehicle with a seat in a first position.

FIG. 6 is a side view of a first embodiment of a harness vehicle with a seat in a second position.

FIG. 7 is a rear perspective, partially exploded view of a first embodiment of a harness vehicle with major components detached.

FIG. 8 is a partially exploded view of a second frame portion of a first embodiment of a harness vehicle.

FIG. 9 is a partial cross section view of a first frame portion of a first embodiment of a harness vehicle.

FIG. 10 is a perspective view of a first frame portion of a first embodiment of a harness vehicle with the first frame in a first, extended configuration.

FIG. 11 is a perspective view of a first frame portion of a first embodiment of a harness vehicle with the first frame in a second, intermediate configuration.

FIG. 12 is a perspective view of a first frame portion of a first embodiment of a harness vehicle with the first frame in a third, folded configuration.

FIG. 13 is a front perspective view of a third embodiment of a harness vehicle.

FIG. 14 is a rear perspective view of a third embodiment of a harness vehicle.

FIG. 15 is a rear perspective view of a first embodiment of a harness vehicle with a first alternate load configuration.

FIG. 16 is a rear perspective view of a first embodiment of a harness vehicle with a second alternate load configuration.

### DETAILED DESCRIPTION OF EMBODIMENTS AND MODES FOR CARRYING OUT THE INVENTION

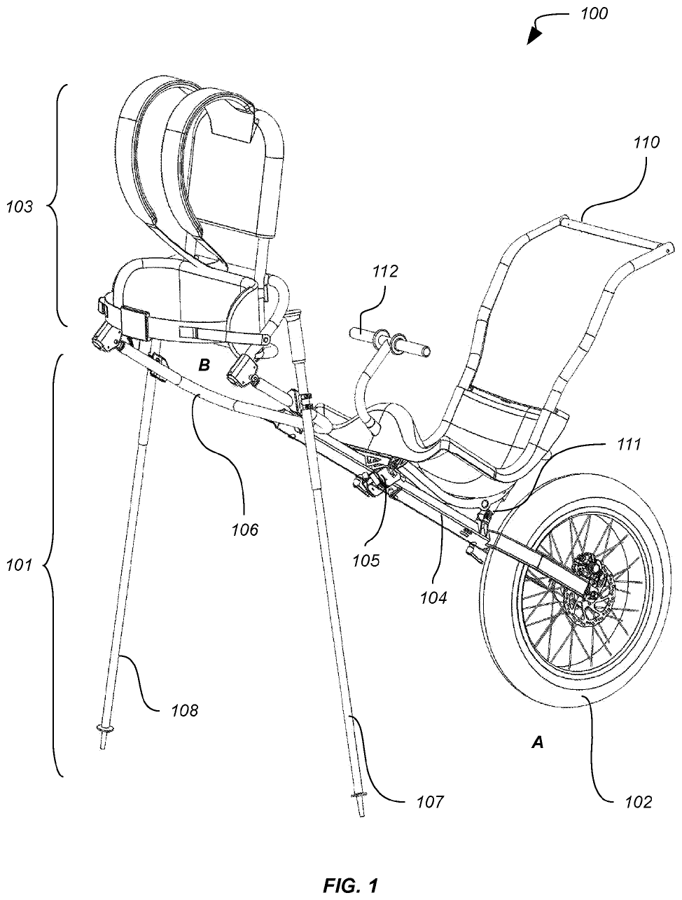

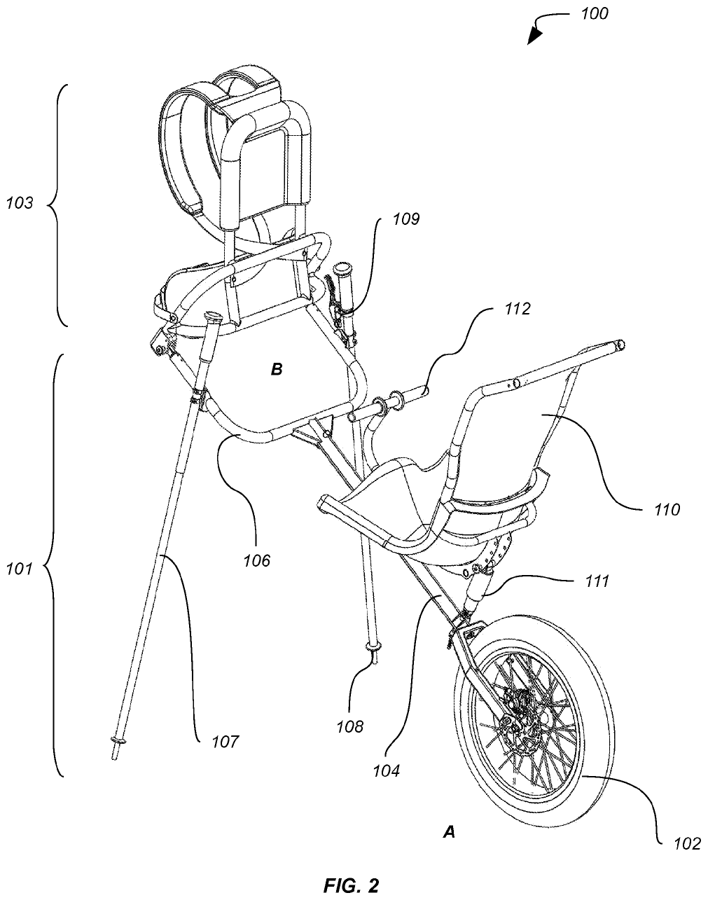

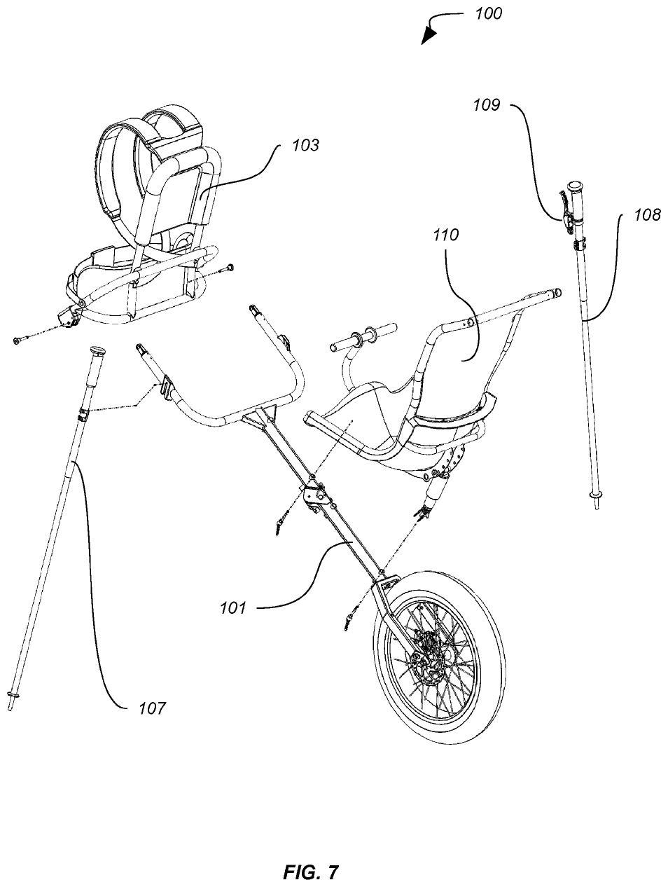

Harness vehicle 100 is described below through one or more exemplary embodiments. Referring to FIGS. 1 through 2, harness vehicle 100 is generally comprised of a first frame 101, wheel 102 located at the rear of and/or beneath the first frame 101, a second frame 103 that is backpack-styled and releasably attachable to the first frame, and a load portion on the first frame 101. Depending on the embodiment, additional components may be included. As shown in FIG. 7, some or all such components may be releasably attachable through suitable fastening means—including bolts, pins, pushpins and quick releases, and the like—to facilitate disassembling the harness vehicle 100 for travel and storage.

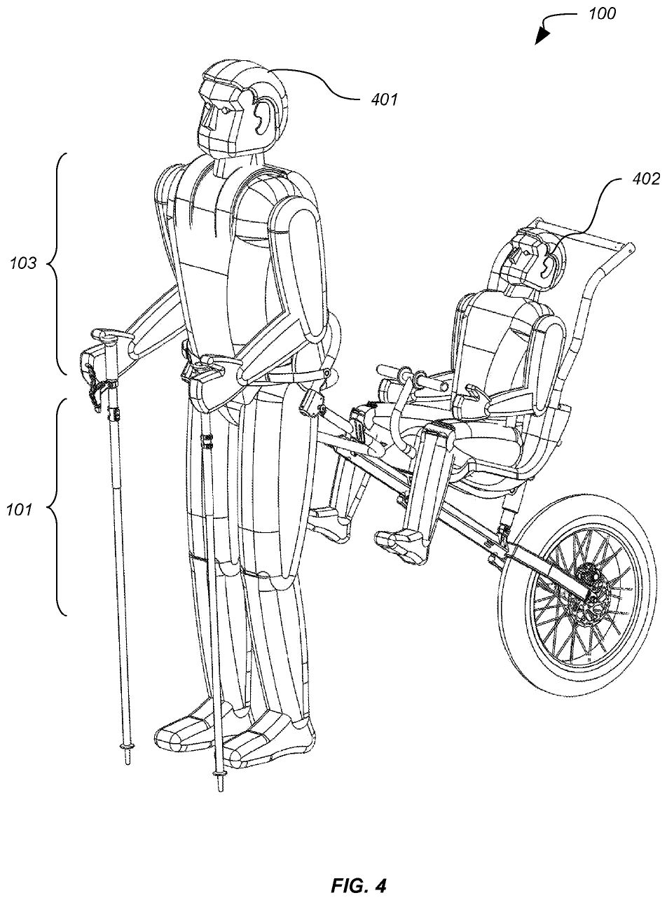

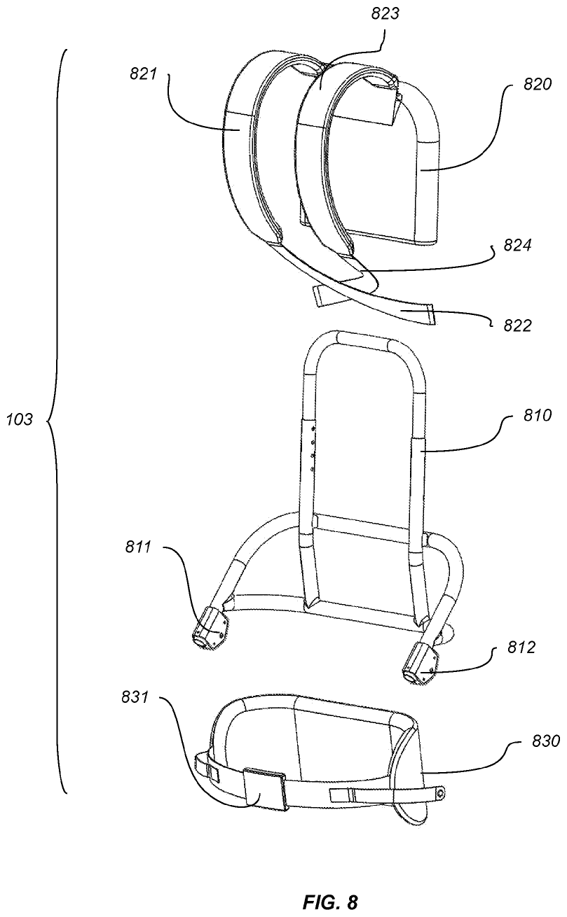

First frame 101 is rigid and may be configured in any number of ways without departing from the purpose and scope of the invention. To provide examples, and referring to FIGS. 1 through 7, first frame 101 has a first end A, a second end B opposite the first end A, and one or more connecting members 104 between the first A and second end B. In the illustrated embodiment, connecting member 104 is singular and elongate with a first fork at the first end A and a second fork 106 at the second end B. Referring briefly to FIG. 9, one or more of the connecting members 104 may have a generally rectangular and/or square cross section 901 configured so that a longitudinal/vertical axis along a diagonal of the square cross section 902 is generally parallel to the central or sagittal plane of the wheel when the harness vehicle 100 is in operation. However, the shape, dimensions, and cross-section of the one or more connecting members may vary without departing from the purpose or scope of the invention.

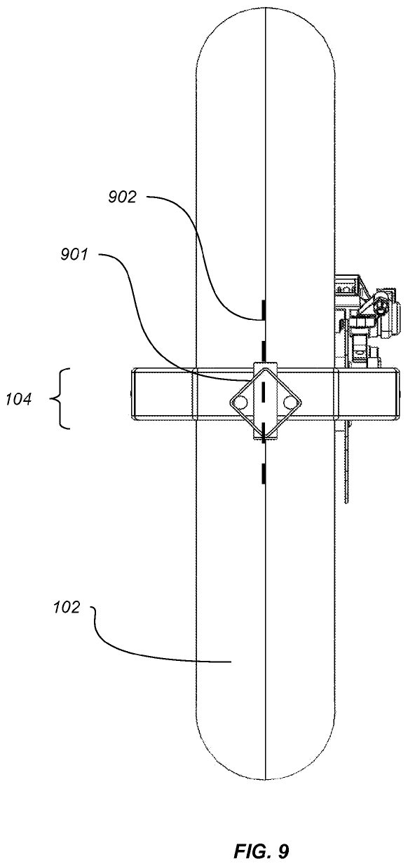

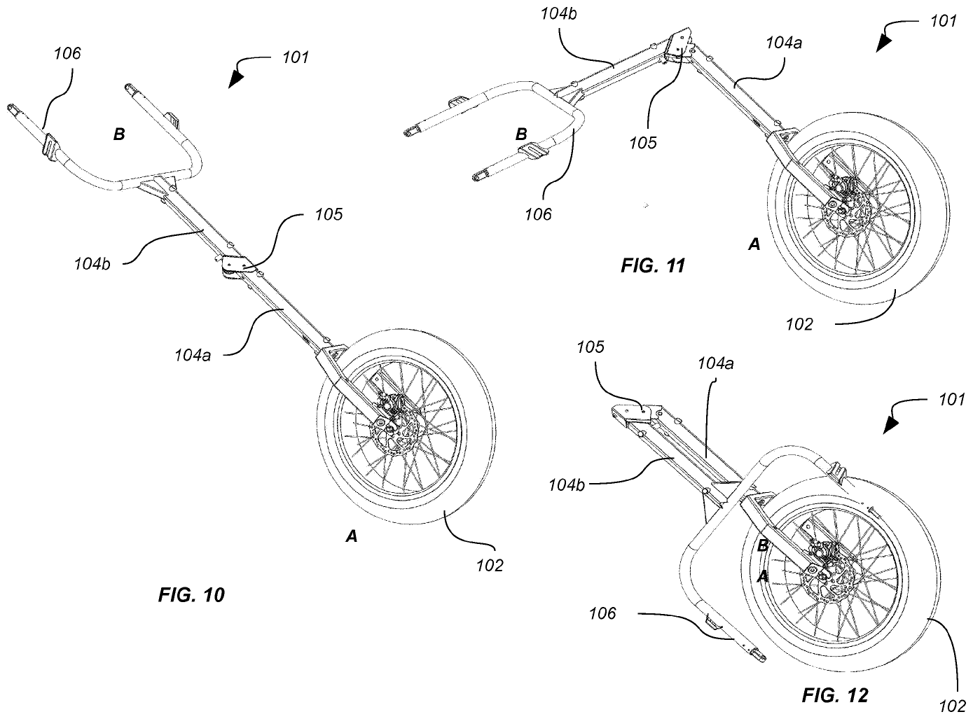

Referring back to FIGS. 1 through 2 and 10 through 12, elongate connecting member 104 may be comprised of sub-parts (e.g., 104a, 104b) and have a hinge 105 (such as, for example, a releasably locking hinge point) that is configured to allow a user to fold the first frame 101 for stowing. In embodiments also employing the angled, square connecting member described above, or in similarly suitable embodiments, the releasably locking hinge point facilitates 90 degrees of relativity between the second fork 106 and the wheel 102 when the first frame 101 is fully extended (see FIG. 10) and parallel relativity (for compactness generally within the same plane) between the second fork 106 and the wheel 102 when the first frame 101 is in a folded or stowed position (see FIG. 12).

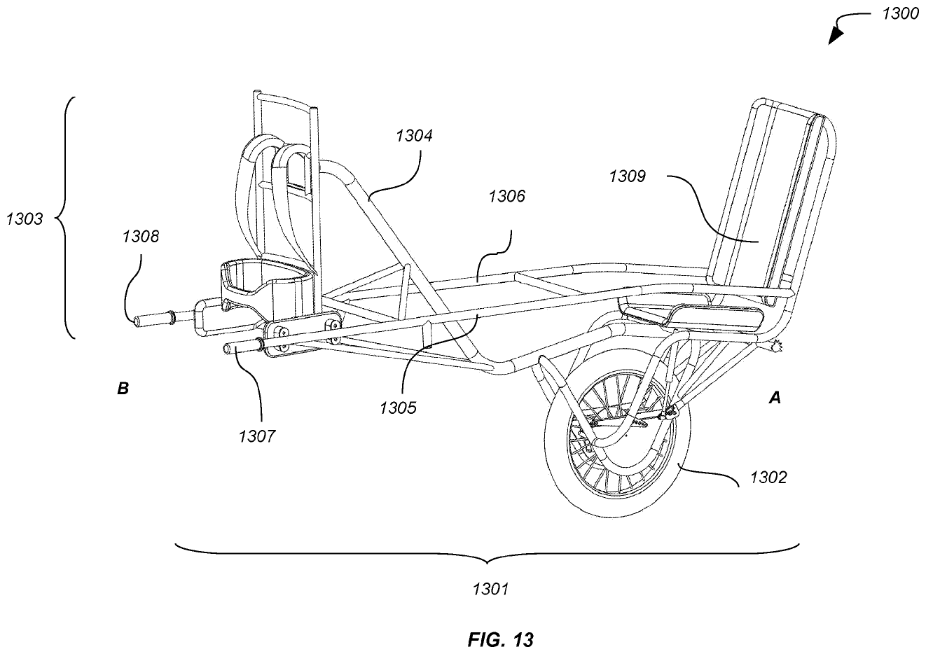

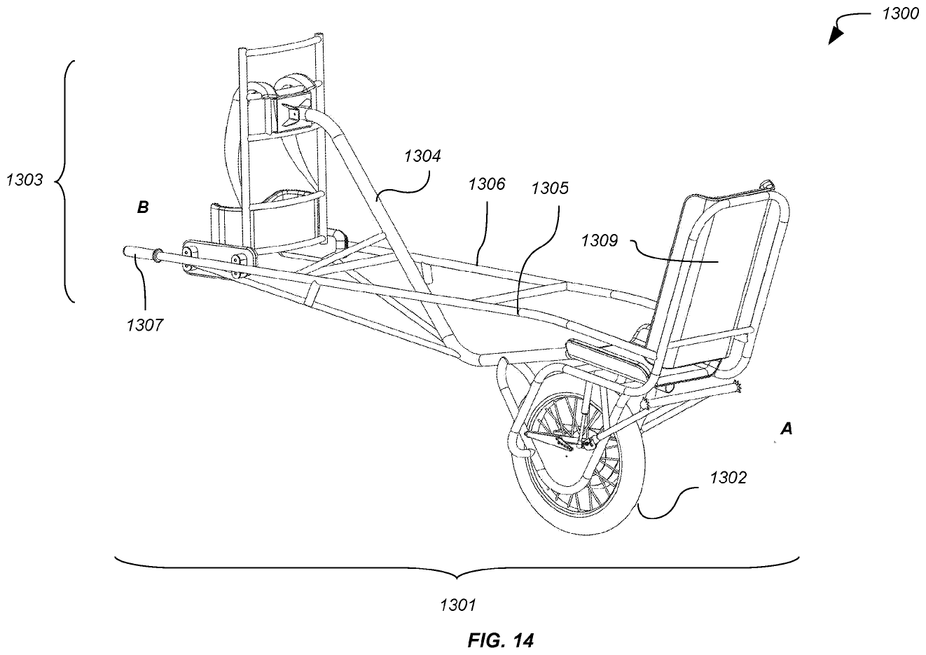

First frame 101 may also have brackets and/or receiving portions to releasably attach one or more trekking poles 107, 108 (including height adjusting and/or telescopic poles) that may or may not be included in and/or used with the harness vehicle 100, depending on the embodiment and user circumstances or conditions. For example, trekking poles may be desired when loads are greater or difficult conditions encountered by a first user, but omitted when loads are lighter or when relatively easier conditions are encountered by a first user. In those embodiments of the harness vehicle 100 that include trekking poles, trekking poles and brackets are configured to form a stand for the harness vehicle 100 that keeps the second end B upright when a user is resting, rigging, and/or away from the harness vehicle 100. In the illustrated embodiment (excepting FIGS. 13 and 14), such brackets are located on second fork 106 adjacent the second end of the first frame 101 and are formed as inverted “U” slots or channels.

A second example of a harness vehicle first frame configuration is shown in FIGS. 13 and 14. First frame 1301 has a first end A, a second end B opposite the first end A, and a plurality of connecting members (e.g., 1304, 1305, 1306) between the first end A and second end B. The plurality of connecting members may have a generally tubular or other suitably shaped cross section or have cross-sections of varying shapes. Connecting members may form user handles 1307, 1308 at the second end B of the first frame 1301.

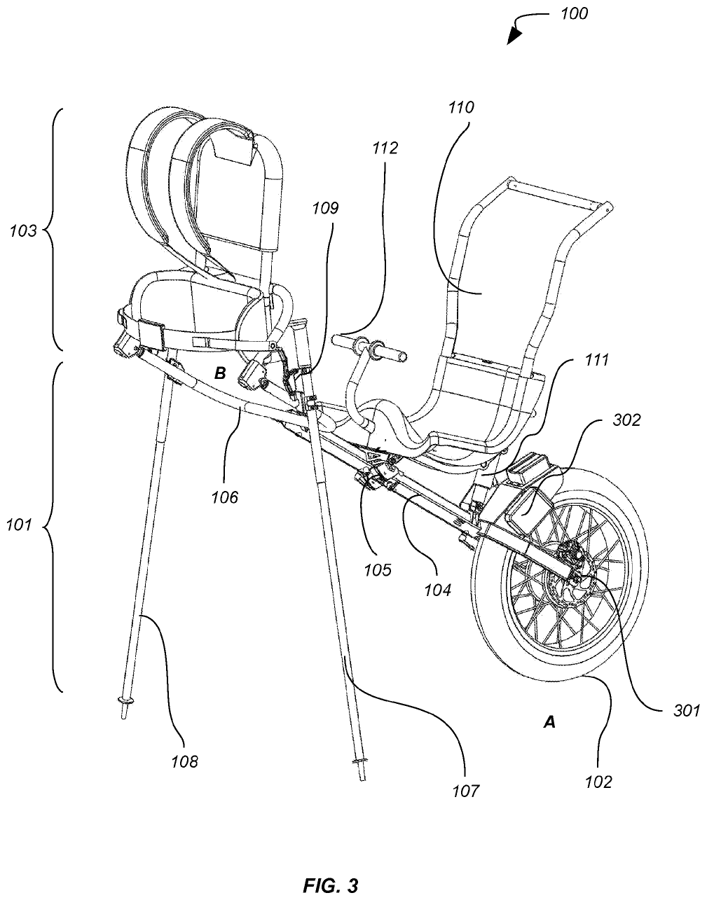

A third example of a harness vehicle first frame configuration is shown in FIG. 3. The embodiment of FIG. 3 includes a powered drive 301 in communication with the wheel 102 through a suitable linkage. Powered drive 301 may be part of a powered drive system for the harness vehicle that includes a chargeable battery 302, motor, throttle controlled by a first user (e.g., adjacent 109 or 109 with brake handle on opposite side) and/or adaptive assistance that scales the amount of assistance by how much drag force a first user is feeling. Likewise, the powered drive system may include adaptive regenerative braking.

Referring back to FIGS. 1-2, across embodiments, the wheel 102 of the harness vehicle 100 may be releasably attachable to the first frame 101 at the first end A. In preferred embodiments, only one wheel (typically centered within the first frame 101) is used with the harness vehicle 100; however, certain embodiments or configurations may use two or more wheels. Wheel 102 may incorporate a braking mechanism such as a disc brake or other suitable braking means with a brake control such as a brake handle 109 located adjacent the second end B of the frame. In the illustrated examples (excepting FIGS. 13 and 14) a brake handle 109 on a trekking pole 108. In other embodiments brake handle 109 may be located on other first user accessible locations such as the first frame 101.

Second frame 103 is configured as a backpack-styled harness so that a user may lift and pull the second end of the first frame A, and as a result, convey the entire harness vehicle 100. Second frame 103 may also be configured in any number of ways without departing from the purpose and scope of the invention. Referring now to FIG. 8, second frame 103 may have a rigid framework 810 with a padded portion 820 having over the shoulder straps 821, 823 and a padded waist portion 830 with a strap and buckle 831. Portions of the rigid framework 810 may include sub-parts and/or members that are telescopically adjustable. Straps (e.g., 822, 824) may be configured for cross-buckling to enhance lateral stability. Second frame 103 may be releasably attachable to the first frame 101 at the second end B of the first frame 101. In the embodiments of FIGS. 1 through 12, this is accomplished with attachment portions at the second end B of the first frame that are configured to be inserted into attachment portions, such as channels of the second frame 811, 812 and secured with suitable fastening means such as pins. The resulting joint may be structured such that the second frame 103 is generally pivotable in a pitch degree of freedom (with respect to the first frame 101), but not generally pivotable in other degrees of freedom such as roll and yaw (with respect to the first frame 101). Such structure allows for the frames to pivot such that natural attitude adjustment may occur with changes in terrain elevation and the roll stability of the first frame can be controlled by a first user through the first frame thereby facilitating hands-free operation by the first user.

The load portion of the harness vehicle 100 may be located on the first frame 101

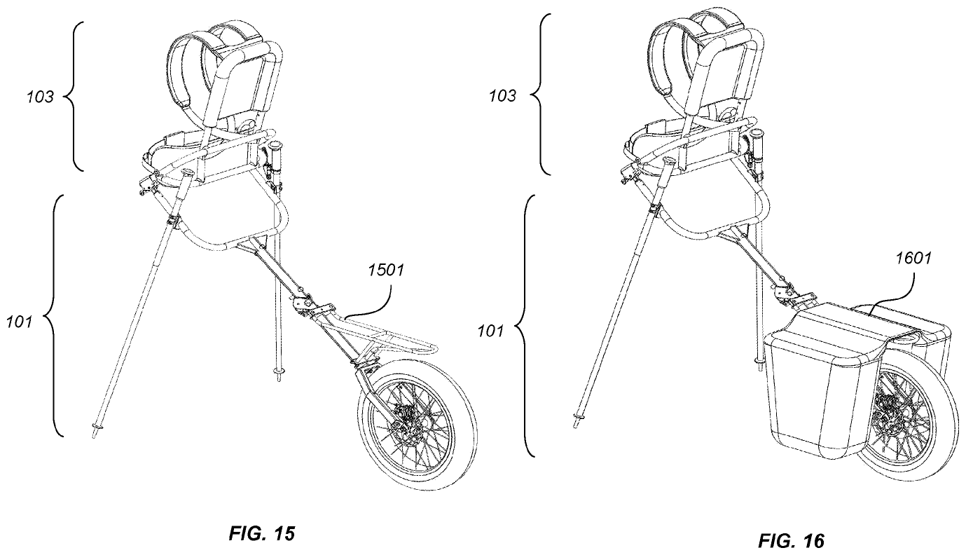

generally between the first A and second B ends. In other embodiments, the load portion may be located elsewhere, such as beyond and/or at first end A (see FIGS. 13 & 14). In various embodiments, load portion is configured for attachment of any number or type of modular and/or releasably detachable load platforms, such as, for example: a chair; seat; saddle; saddle bag (see 1601, FIG. 16); container; platform; rack (see 1501, FIG. 15); and/or weight. In a preferred embodiment shown in FIGS. 1 through 7, the load platform is a seat 110 optimized to retain a second user or passenger, and/or a physically disabled person. This optimization may include a high-back/framed mesh bucket seat 110 with leg contours configured to retain the passenger on the harness vehicle 100 so that the passenger's legs straddle (slightly apart) the connecting member 104 of the first frame 101. So configured, a first/pulling user's legs have more rear space for strides without colliding and/or causing interference with a passenger's legs.

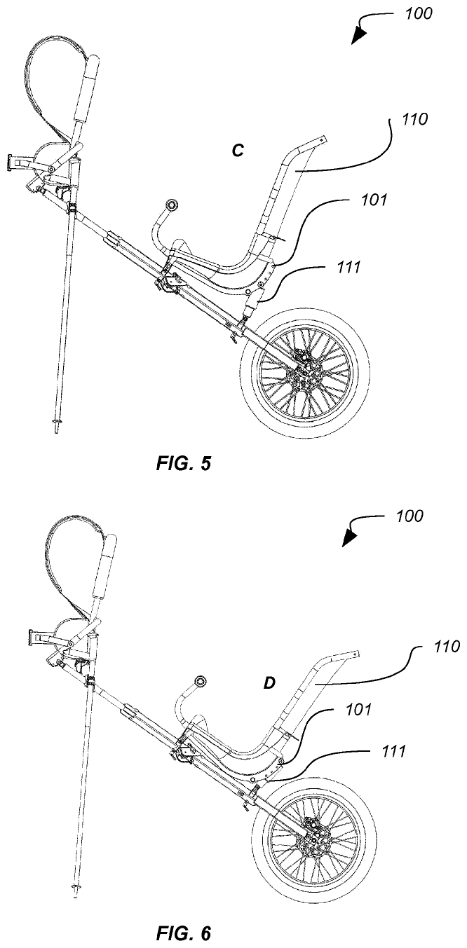

Certain embodiments may include a shock or dampener 111 that may be attached, for example, between the seat 110 and the first frame 101. Referring specifically to the embodiment of FIGS. 5 and 6, seat 110 may be configured to achieve two or more positions C, D of angled recline, including in combination with shock or dampener 111. This may be accomplished with seat attachment points of varying elevation that correspond to the top end of the shock or dampener 111. Harness vehicle 100 and/or seat 110 may also have removably attachable passenger handlebar 112.

Certain embodiments of the harness vehicle may include additional or other features such as differently configured suspension systems, self-stabilization systems, and/or powered drives. The harness vehicle may enable the carrying of a single passenger or multiple passengers seated in serial, with or without additional cargo. In certain embodiments, the positioning of the passenger(s) and/or cargo may be adjusted forward or aft of the wheel(s) to enable the pulling user to adjust how much weight is borne by their hips and shoulders.

So configured, the harness vehicle set forth above solves the problem of providing outdoor access to persons of disability and those that care for and love them, as well as providing versatility for other applications that require a person to convey a load with an optimized human-powered means.

The present invention may be embodied in other specific forms without departing from its spirit or essential characteristics. The described embodiments are to be considered in all respects only as illustrative and not restrictive. For example, the harness vehicle need not be limited in application to providing transport to disabled persons. For example, the harness vehicle may be used to carry able-bodied persons and passengers whose endurance does not match that of the first user. The harness vehicle may also be configured for applications such as game carry (in hunting) and weight and/or exercise training (in fitness). The scope of the invention is, therefore, indicated by the appended claims, and the claims to be set forth in the corresponding application, rather than by the foregoing description. All changes which come within the meaning and range of equivalency of the claims are to be embraced within their scope.

I claim:

1. A harness vehicle comprising:
a first frame with a first end, a second end opposite the first end, and one or more connecting members between the first and the second end;
a wheel releasably attachable to the first frame at the first end;
a second frame releasably attachable to the first frame at the second end of the first frame, the second frame configured as a backpack-styled harness to allow a user to lift and pull the second end of the first frame; and
a load portion located on the first frame generally between the first and second ends.

2. The harness vehicle of claim 1, wherein the harness vehicle has only one wheel.

3. The harness vehicle of claim 1, wherein the one or more connecting members has a releasably locking hinge point configured to allow a user to fold the first frame for stowing.

4. The harness vehicle of claim 1, the second frame configured as a backpack-styled harness further comprising a rear frame portion, a first frame connector portion connected to the rear frame portion, and one or more over-the-shoulder straps connected to the rear frame portion.

5. The harness vehicle of claim 1, further comprising one or more of the following configured to releasably attach to the load portion: a chair, a seat, a saddle, a saddle bag, a bag, platform, rack, and a container.

6. The harness vehicle of claim 1, further comprising a releasably attachable high-backed chair configured for a passenger.

7. The harness vehicle of claim 1, further comprising one or more trekking poles configured to attach to the first frame adjacent the second end of the first frame.

8. The harness vehicle of claim 1, further comprising a braking mechanism with a brake handle adjacent the second end of the first frame.

9. The harness vehicle of claim 1, further comprising a power-assist mechanism with an electric motor to drive the harness vehicle.

10. The harness vehicle of claim 1, wherein the harness vehicle is configured to allow a user to convey a load generally hands-free.

11. A harness vehicle comprising:
a first frame with a first end, a second end opposite the first end, and one or more connecting members between the first and the second end, the one or more connecting members having a locking hinge point configured to allow a user to fold the first frame for stowing;
only one wheel releasably attachable to the first frame at the first end;
a second frame releasably attachable to the first frame at the second end of the first frame, the second frame configured as a backpack-styled harness to allow a user to lift and pull the second end of the first frame, the second frame having a rigid rear frame portion, a rigid first frame connector portion connected to the rigid rear frame portion, and over-the-shoulder straps connected to the rigid rear frame portion; and
a load portion located on the first frame generally between the first and second ends; and
one or more of the following configured to releasably attach to the load portion: a chair, a seat, a saddle, a saddle bag, a bag, platform, rack, and a container.

12. The harness vehicle of claim 11, further comprising a releasably attachable high-backed chair configured for a passenger.

13. The harness vehicle of claim 11, wherein the one or more connecting members has a generally square cross section configured so that a longitudinal axis along a diagonal of the square cross section is generally parallel to the central plane of the wheel when the harness vehicle is in operation.

14. The harness vehicle of claim 11, further comprising one or more trekking poles configured to attach to the first frame adjacent the second end of the first frame.

15. The harness vehicle of claim 11, further comprising a braking mechanism with a brake handle adjacent the second end of the first frame.

16. The harness vehicle of claim 11, further comprising a power-assist mechanism with an electric motor to drive the harness vehicle.

17. The harness vehicle of claim 11, wherein the harness vehicle is configured to allow a user to convey a load generally hands-free.

18. A harness vehicle comprising:
a first frame with a first end, a second end opposite the first end, and one or more connecting members between the first and the second end, the one or more connecting members further
having a locking hinge point
configured to allow a user to fold the first frame for stowing;
only one wheel releasably attachable to the first frame at the first end;
a second frame releasably attachable to the first frame at the second end of the first frame, the second frame configured as a backpack-styled harness to allow a user to lift and pull the second end of the first frame, the second frame having a rigid rear frame portion with padding, a rigid first frame connector portion connected to the rigid rear frame portion, and over-the-shoulder straps connected to the rigid rear frame portion;
a load portion located on the first frame between the first and second ends; and
a releasably attachable high-backed chair configured for a passenger;
wherein the one or more connecting members has a generally square cross section configured so that a longitudinal axis along a diagonal of the square cross section is generally parallel to the central plane of the wheel when the harness vehicle is in operation; and
wherein the harness vehicle is configured to allow a user to convey a passenger generally hands-free.
